(19) United States
(12) Patent Application Publication
(10) Pub. No.: US 2001/0012257 A1
(43) Pub. Date: Aug. 9, 2001

(54) Optical disk and method of apparatus for reproducing data from the same optical disk

(76) Inventors: Katsumi Suzuki, Chofu-shi (JP); Takashi Yoshizawa, Odawara-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/814,700

(22) Filed: Mar. 23, 2001

Related U.S. Application Data
(63) Continuation of application No. PCT/JP00/05932, filed on Aug. 31, 2000.

(30) Foreign Application Priority Data
Aug. 31, 1999 (JP) 11-246577

(51) Int. Cl. G11B 7/0037; G11B 7/135; G11B 7/24; G11B 7/125

(52) U.S. Cl. 369/94; 369/112.23; 369/275.2; 369/121; 369/286; 369/100

(57) ABSTRACT

The thickness of the transparent substrate of an optical disk has been selected from the range from 0.2 mm to 0.4 mm. The wavelength of a light beam passing through the transparent substrate has been selected from the range from 400 to 420 nm. The numerical aperture of an objective for converging the light beam has been selected from the range from 0.60 to 0.75.

### CROSS-REFERENCE TO RELATED APPLICATIONS

This is a Continuation of Application PCT/JP00/05932, filed Aug. 31, 2000.

This application is based upon and claims the benefit of priority from the prior Japanese Patent Application No. 11-246577, filed Aug. 31, 1999, the entire contents of which are incorporated herein by reference.

### BACKGROUND OF THE INVENTION

This invention relates to an optical disk and a method of and apparatus for reproducing data from the optical disk, and more particularly to an improvement in an optical disk optimized to record data with high density and to a method of and apparatus for reproducing the data from the optical disk.

Furthermore, the present invention relates to an optical disk on whose one side two phase-change layers (hereinafter, just referred to as a single-sided two-layer phase-change optical disk) capable of recording, erasing, and reproducing are provided and a method of and apparatus for reproducing data from the optical disk, and more particularly to an optical phase-change optical disk on whose one side two phase-change layers capable of recording and erasing are provided, the two layers being phase-changed reversibly between the amorphous state and the crystalline state when being hit by a light beam and being joined together with an adhesive layer of a specific thickness, and to an improvement in the high-density recording on a single-sided two-layer phase-change optical disk capable of recording, erasing, and reproducing data onto and from the disk by converging the laser beam from one side on each layer, and improvements in an apparatus for and method of reproducing data from the optical disk.

In recent years, optical disks have attracted attention because they can be used as large memory. Actually, DVD (Digital Versatile Disk), a high-density optical disk capable of reproducing two hours of moving pictures, has been put to practical use. There have been strong demands for optical disks with higher recording density and larger storage capacity than those of the currently available optical disks. To meet the demands, the development of various element techniques has been needed. It is known that, for example, the technique for reproducing smaller pits previously recorded in a disk by use of a finer condensed spot is effective in realizing a higher-density optical disk. As is well known, the size of the condensed spot is proportional to the wavelength of the laser light from an light source and is inversely proportional to the numerical aperture (NA) of an objective. As for wavelength, compact disks, early optical disks, have used laser beams with a wavelength ranging from 780 to 830 nm. At present, a semiconductor laser that generates a laser beam with a wavelength ranging from 685 to 635 nm belonging to the red zone has been put to practical use Moreover, semiconductor lasers belonging to the wavelength range of blue from 400 to 420 nm have been developed to the extent that they can be almost put to practical use. On the other hand, the technique for increasing the numerical aperture of an objective has been studied. For example, as disclosed in Proceedings of “INTERNATIONAL SYMPOSIUM ON OPTICAL MEMORY AND OPTICAL DATA STORAGE,” 1996, OFA2-1, pp. 345-347, a method of constructing an objective using two lenses to realize as high a numerical aperture as 0.85 to 0.90 has been proposed.

Optical disks are roughly divided into three types of disks: playback-only disks, such as CDs, postscript-type disks capable of writing in data only once, such as CD-Rs, and rewritable disks capable of reproducing, recording, and erasing, such as computer external memory. Furthermore, the rewritable disks are roughly divided into magneto-optical disks and phase-change disks, which differ from each other in the methods of reproducing, recording, and erasing. The phase-change optical disk uses a recording film that phase-changes reversibly between the amorphous state and the crystalline state when being struck by a laser beam. In such a disk, the projection of a laser beam forms a recording mark (in the amorphous state) and the background (in the crystalline state), thereby recording data. The recording mark (in the amorphous state) and the background (in the crystalline state) differ in reflectivity. The difference in reflectivity is sensed, thereby reproducing the data. Whether the part of the recording film on which the laser has been projected becomes amorphous (a mark) or crystalline (the erased state) depends on whether the temperature at the projected part exceeds the melting point or the crystallizing point. Therefore, a laser beam intensity-modulated between a reference temperature lying between the melting point and the crystallizing point and a reference temperature equal to or higher than the crystallizing temperature is generated. By scanning the recording film with the laser beam, overwriting can be done, that is, erasing and recording can be done at the same time.

To increase the recording density of such an optical disk, the diameter of the condensed spot has been made smaller by shortening the wavelength of the laser light explained above and a land-groove recording method (L/G recording method) has been used. In a conventional optical disk, data is recorded only on the recording film in the groove or only on the bank called the land between grooves. In the land-groove recording method, data is written on both of the groove and the bank. Specifically, the following method has been used: the depth of the groove is optically determined in such a manner that, when the laser beam is scanning the groove, the mark recorded on the bank is made optically invisible and that, when the laser beam is scanning the bank, the recording mark written on the groove is made optically invisible. This method enables the data to be written stably onto both of the groove and the bank.

As described above, at the time of the commercialization of DC disks, the wavelength of the semiconductor laser provided on the optical head was set to 780 mm, the NA (numerical aperture) of the objective was set to 0.45, and the thickness of the DC disk was set to 1.2 mm. With the recent advent of DVD disks, however, these parameters have been determined as follows. In a DVD drive unit, the semiconductor laser wavelength of the optical head has been set to 650 nm, the numerical aperture NA has been set to 0.6, and the substrate thickness of the DVD disk has been set to 0.6 mm.

The reason why these parameters have been changed all at once in the transition period from CDs to DVDs is that it is impossible to increase the recording density any further unless the preset parameters of the CD disk are changed. Specifically, it is well known that the diameter of the condensed spot of the optical head is proportional to λ/NA, where the wavelength of the laser is λ and the numerical aperture of the lens is NA. Therefore, it is common practice that the wavelength is made shorter and the NA is made as large as possible to make the spot diameter smaller. If the thickness of the disk substrate is t, provision is made so as to set smaller a coma proportional to t(NA)³/λ. Specifically, although setting the NA larger and λ shorter as described above enables the data to be recorded with high density, the coma becomes large. To cancel this, such a structure as makes the substrate thinner is used.

Recently, for post-DVD, various attempts have been made to set the wavelength of the semiconductor laser to the wavelength of blue near 410 nm and make the NA as large as possible, thereby thinning the substrate on the laser-projected side that much. In one example, a laser is caused to enter at the 0.1-mm-thick cover-layer side and record the data at a wavelength of 410 nm with an optical head whose NA has been set at 0.85. The reason why the cover layer, not the substrate, is 0.1 mm is that since a 0.1-mm-thick substrate cannot provide a mechanical (or physical) stiffness and therefore cannot maintain the mechanical accuracy for an ordinary 120-mm-diameter disk, the mechanical stiffness of the disk is maintained using a dummy substrate, a 0.1-mm-thick cover layer is applied to or laminated with the surface of the dummy substrate, and the laser light is projected from the cover layer side, not the substrate side, thereby achieving high-density recording.

In such a situation, an attempt has been made to make larger only the on-line capacity of recording and reproducing on one side, with the wavelength of the semiconductor laser remaining in the red zone (or 650 nm) and the recording density being almost the same as that of a single-sided 4.7-GB DVD-RAM currently being standardized. In ISOM '98 (International Symposium on Optical Memory Oct. 20-22, 1998), Th-N-05 “Rewritable Dual Layer Phase-Change Optical Disk,” a phase-change two-layer disk that enables recording and reproducing to be done on one side by laser projection (hereinafter, abbreviated as a single-sided two-layer RAM disk) has been proposed as explained below.

In FIG. 1, the configuration of a single-sided two-layer RAM disk written in the above thesis is schematically shown. In a simple explanation, the single-sided two-layer RAM disk is such that a first RAM layer 132 is provided on a polycarbonate (PC) substrate 131 and a second RAM layer 134 is provided on another PC substrate 133 and that these layers are laminated together with a 40-μm-thick UV curing resin film 135. The first RAM layer 132 is formed so as to have a structure where a ZnS—SiO₂ protective film 132A, a GeSbTe recording layer 132B, and a ZnS—SiO₂ protective film 132C are stacked one on top of another in that order on the PC substrate. The second RAM layer 134 is formed so as to have a structure where an Au interference film 134D, a ZnS—SiO₂ protective film 134A, a GeSbTe recording film 134B, a ZnS—SiO₂ protective film 134C, and an Al—Cr reflecting film 134E are stacked in that order on the UV curing film 135.

An objective 136 that condenses a laser beam is controlled by a focus servo circuit (not shown). The objective 136 switches between a laser beam LA1 in a first focus state that is focused on the recording film 132B of the first RAM layer 132 and a laser beam LA2 in a second focus state that is focused on the recording film 134B of the second RAM layer 134. In the corresponding focus state, the data is recorded onto or reproduced from each of the recording films 132B and 134B. If the recording capacity of each layer is assumed to be standardized 4.7-GB per side, the total capacity of two sides amounts to single side 9.4 GB per single side. Taking into account crosstalk between the first RAM layer 132 and second RAM layer 134 by optical interference, the recording density is reduced a little to the extent that the recording capacity of each layer is decreased to 4.25 GB, with the result that the total capacity of two layers is determined to be 8.5 GB.

Next, an optical design technique for a single-sided two-layer RAM disk described in ISOM '98 (International Symposium on Optical Memory Oct. 20-22, 1998), Th-N-05 “Rewritable Dual Layer Phase-Change Optical Disk” will be explained. In the basic design idea, for the laser beam LA2 condensed by the objective 136 to also reach the second RAM layer, the first RAM layer 132 has a high transmittance as a whole. Because the second RAM layer 134 has to be capable of recording and reproducing even with a weak laser beam passed through the first RAM layer 132, it must have a high sensitivity as a whole in recording and a high reflectivity for the laser beam in reproducing.

In addition, from the viewpoint of signal processing, the playback signal from the first RAM layer 132 and that from the second RAM layer 134 must be almost at the same level. The magnitude of the playback signal is represented by the difference in reflectivity between the recording mark (amorphous part) and the erased part around the mark (crystalline part) (hereinafter, referred to as the amount of change in the reflectivity).

If the reflectivity of the first RAM layer 132 is r1, its transmittance is t1, and the reflectivity of the second RAM layer 134 is r2, the amount of change in the reflectivity from the first RAM layer is ΔR1=Δr1. Here, Δr1 is the amount of change in the reflectivity of the first RAM layer itself. The amount of change in the reflectivity from the second RAM layer is equal to the value obtained by multiplying a change Δr2 in the reflectivity from the second RAM layer 134 by the transmittance of the first RAM layer 132 twice, because the incident light passes through the first RAM layer, is reflected by the second RAM layer, and passes through the first RAM layer 132 again. Thus, the absolute amount of change ΔR2 in the reflectivity from the second RAM layer is ΔR2=Δr2×t1×t1. As described above, the magnitude of the playback signal from the first RAM layer 132 and the magnitude of the playback signal from the second RAM layer 134 must be almost at the same level from the viewpoint of signal processing and meet the equation ΔR1=ΔR2.

Next, the individual parameters will be defined. Let the reflectivity of the crystal in the first RAM layer be r1c, its absorbance be α1c, its transmittance be t1c, the reflectivity of the amorphous substance be r1a, its absorbance be α1a, and its transmittance be t1a: then r1c+α1c+t1c=100 and r1a+α1a+t1a=100.

In the above thesis, the reflectivity r1c is set to 9% so that the servomechanism may function electrically even when the first RAM 132 has been unrecorded (in the crystalline state).

The reflectivity r1c should be as large as possible, taking only the servomechanism into account. As described above, however, since the reflected light beam from the second RAM layer 134 returned to the objective 136 passes through the first RAM layer twice, making the reflectivity r1c too large causes the intensity of the reflected light beam from the second RAM layer 134 to become very small. In anticipation of this, the reflectivity r1c is presumed to have been set to that percentage.

Next, under the above-described conditions, the aforementioned parameters are determined as follows. First, because the incident light beam has to reach the second RAM layer 134 after it passes through the first RAM layer 132, the transmittance tic of the first RAM layer 132 is set to 50%. To set the transmittance to a value as large as 50%, the reflecting film 134E must generally be made of metal for cooling in a phase-change optical disk. Moreover, no reflecting film is provided on the disk of the first RAM layer 132. Making the transmittance of the first RAM layer 132 too large causes the absorbance of the first RAM layer 132 to become small, raising the problem of permitting the recording sensitivity of the first RAM layer 132 to decrease.

After the two points have been set and the structure of the first RAM layer 132 has been designed in the phase-change optical disk, the other parameters are then determined automatically.

As a result of the film design, the individual parameters of the first RAM layer are as follows:

r1c=9%, α1c=41%, t1c=50%

r1a=2%, α1a=28%, t1a=70%

Thus, the magnitude of the playback signal from the 1c layer 132 is as follows:

the magnitude of the playback signal=the amount of change ΔR1 in the reflectivity

=r1c−r1a (the reflectivity of crystalline substance−the reflectivity of amorphous substance)

=7%

the magnitude of the playback signal=the amount of change ΔR2 in the reflectivity

=Δr2×t1×t1=the magnitude of the playback signal from the first RAM layer=6%

Thus, substituting the transmittance tic of 0.5 (50%) into the transmittance t1 and doing simple calculations give the result that ΔR2 is 24%.

The disk of the second RAM layer 134 must have a high sensitivity so as to be able to do recording even with a small amount of light passed through the first RAM layer 132 as described above. In other words, it is necessary to set the absorbance of the unrecorded part (in the crystalline state) high. Moreover, to prevent the absorbed head from escaping and the head from escaping from the reflecting film, the reflecting film must be set thin so that some amount of light may pass through the film.

Under the above conditions, when the film structure of the second RAM layer is designed, with ΔR2=24%, it follows that

r2c=13%, α2c=65%, t2c=22%

r2a=37%, α2a=37%, t2a=26%

where r2c, α2c, and t2c are the reflectivity, absorbance, and transmittance of the second RAM layer 134 in the crystalline state, respectively, and r2a, α2a, and t2a are the reflectivity, absorbance, and transmittance of the second RAM layer 134 in the amorphous state. It goes without saying that the amount of change in the reflectivity of the second RAM layer 134 is ΔR2=r2a−r2c=24%.

It should be noted that the second RAM layer 134 is an L-to-H medium where the reflectivity r2a of the recording mark (amorphous part) is higher than the reflectivity r2c of the erased state (crystalline part).

The method of increasing the recording density by making the numerical aperture of the objective larger has various problems explained below.

Firstly, the method has the following problem: the characteristic in reproducing the information deteriorates further in the presence of such stains as dirt or fingerprints stuck to the surface of the disk or a flaw in the disk surface. In a conventional DVD system, since the numerical aperture of the objective is 0.60 and the thickness of the transparent substrate is 0.6 mm, the beam diameter at the disk surface, or the beam diameter when the light beam strikes the disk, is about 0.6 mm as a result of simple calculations. On the other hand, as in the known example described above, when the numerical aperture is as large as 0.85, the beam diameter at the disk surface is as small as about 0.12 mm. Stains of the same size are expected to take place at the disk surface unless the same disk manufacturing method and treatment are executed, regardless of the thickness of the transparent substrate. Thus, there is a great difference in the relative ratio of the size of the stained parts to the size of the light beam passing through the parts. As pictorially shown in FIGS. 2A to 2C, the aforementioned known example of realizing a large numerical aperture permits the area of the stained part to become relatively larger to the beam diameter than the DVD system, resulting in the fear that the example may be more significantly affected. In FIGS. 2A to 2C, the black dots represent the stained parts and the circles enclosing the black dots indicate the beam diameters.

Secondly, as shown in the known example, to realize an objective with a numerical aperture of 0.85, the objective cannot be composed of a single lens, taking practical use into account, even if the objective is designed to be an spherical lens. When a plurality of lenses are used, the alignment of lenses, that is, the decentering, the relative inclination, and the lens-to-lens space, requires high accuracy. This means that not only member costs increase to secure the accuracy of each lens, but also adjustment costs increase for high-accuracy alignment. This involves a great modification to the configuration of the optical head with a single lens widely used in optical disk drives, which results in a great difficulty in establishing a manufacturing line.

Thirdly, an objective with a large numerical aperture requires not only an improvement in the installing accuracy to the optical head but also the maintenance of the reliability. As described later, the objective with a large numerical aperture might condense light and degrade the optical quality of the condensed spot projected onto pits responsible for information recording. This causes a problem: the aberration increases in proportion to the numerical aperture and therefore becomes large. A coma occurring mainly due to, for example, a relative inclination between the disk and the objective, a relative inclination between the individual lenses, or the decentering increases in proportion to the cube of the numerical aperture. An spherical aberration occurring mainly due to errors in the thickness of the transparent substrate or errors in the space between lenses increases in proportion to the numerical aperture raised to the fourth power. Such factors causing an aberration might lower the reliability because it leads to not only a change in the member accuracy or the optical head assembly and adjustment accuracy but also the change of the drive unit with time or changes under various circumstances. For this reason, the drive unit is required to have a higher reliability than ever. The necessity of maintaining such a high reliability leads to the disadvantage of increasing manufacturing cost.

Fourthly, the operating distance corresponding to the distance between the part of the objective closest to the disk and the disk surface decreases in proportion to the numerical aperture from the viewpoint of optical design. For example, when the numerical aperture is 0.60 mm, the operating distance is 1.5 to 1.8 mm, whereas when the numerical aperture is about 0.85, the operating distance is as narrow as 0.25 to 0.30 mm, which is a problem. When the operating distance is short, the possibility that the objective will come into contact with the disk becomes stronger when an impact is externally applied, which makes the disk surface or the objective surface liable to be damaged. To avoid this, sophisticated servo control is needed, which leads to a disadvantage.

Concerning a method of increasing the storage capacity of an optical disk capable of phase-change recording, reproducing, and erasing, there are two methods as described earlier: one method of using blue laser, a high NA objective lens, and a cover layer as thin as 0.1 mm and the other method of using the same substrate thickness and laser wavelength as those in the existing DVD-RAM, providing two layers on one side, and almost doubling only the on-line capacity accessible from one side.

These two methods have the following disadvantages. When high-density recording is done with blue laser by means of the high NA objective and the 0.1-mm thick cover layer, the 0.1-mm-thick substrate cannot assure the mechanical accuracy of the 130-mm-diameter disk. Therefore, the substrate must be laminated to a dummy substrate to maintain the mechanical accuracy as described earlier. In the dummy substrate, pits and grooves have been formed in predetermined formats. On the resulting substrate, a phase-change layer of a specific layer structure is stacked. On the phase-change layer, a 0.1-mm-thick surface cover layer is coated. As a result, in this method, it is impossible to record data into the single-sided two-layer RAM.

Furthermore, as described later, to change the target capacity on one side from 15 GB to 20 GB, the numerical aperture NA of the objective has to be set in the range from 0.75 to 0.85. Generally, the larger the NA of the objective becomes, the higher the price is and the more difficult the manufacturing processes are or the worse the yield is.

On the other hand, in a two-layer RAM disk, its on-line capacity can be almost doubled. However, since the two-layer RAM disk has basically used the same technique as that of DVD, it is impossible for the two-layer RAM disk to enable higher-density recording than DVD.

### BRIEF SUMMARY OF THE INVENTION

An object of the present invention is to provide an optical disk optimized to make the recording density higher.

Another object of the present invention is to provide a phase-change optical disk capable of not only making the storage capacity larger by increasing the recording density but also effecting optimized recording, reproducing, and erasing.

To achieve the foregoing objects, the inventors of the present invention have found the optimum relationship between the thickness of the disk transparent substrate and the numerical aperture of the objective in realizing a higher recording density. Specifically, in the present invention, an optical disk is such that the thickness of the transparent substrate is selected from the range from 0.2 mm to 0.4 mm, the wavelength of the light beam passing through the transparent substrate is selected from the range from 400 to 420 nm, and the numerical aperture of the objective to cause the light beam to converge is selected from the range from 0.60 to 0.75.

In the phase-change optical disk capable of recording, reproducing, and erasing, an attempt should be made to increase the mass-productivity of optical disks to suppress the unit price of the disk on the assumption that tilt errors related to a warp in the disk as found in the existing DVD video or DVD-ROM occur. In addition, to record data on an optical disk with high density, the numerical aperture NA of the optical disk is required not to be smaller than 0.60. To suppress a coma occurring due to a tilt of the existing DVD to almost the same degree of coma of the existing DVD, the thickness of the transparent layer of the optical disk is required not to be larger than 0.4 mm, as seen from FIG. 5 explained later.

Use of a two-set objective requires the optical alignment of the two lenses, makes the mass-productivity worse than use of a single objective, and has a reliability problem. In addition, the two-set objective tends to permit a spherical error to occur due to thickness errors in the transparent layer of the disk. Moreover, its operating distance becomes a serious problem. For these reasons, it is desirable that the objective should be a single lens, or a one-set objective. In a one-set objective, the upper limit of the numerical aperture is about 0.75. To realize a two-layer structure of an optical disk, the thickness of the transparent layer of an optical disk is required not to be smaller than 0.2 mm as seen from the graph of FIG. 5. From such a viewpoint, according to the present invention, optical disks are provided as follows.

(1) According to the present invention, there is provided an optical disk comprising: a transparent substrate on which a light beam which is converged by an objective whose numerical aperture is determined in the range from 0.60 to 0.75 and whose wavelength is selected from the range from 400 to 420 nm is projected and whose thickness is determined in the range of 0.2 mm to 0.4 mm; and a recording layer which is formed on the transparent substrate and searched by the light beam passed through the transparent substrate.

(2) According to the present invention, there is provided an optical disk related to the invention in item (1) in which the numerical aperture of the objective is set substantially to 0.65 and the thickness of the transparent substrate is set substantially to 0.3 mm.

(3) According to the present invention, there is provided an optical disk comprising:

a transparent substrate on which a light beam which is converged by an objective whose numerical aperture is determined in the range from 0.60 to 0.75 and has the wavelength of blue near about 410 nm is projected and whose thickness is determined in the range of 0.2 mm to 0.4 mm; and

a recording layer which is formed on the transparent substrate and which is searched, reproduced from, recorded into, or erased from by the light beam passed through the transparent substrate.

(4) According to the present invention, there is provided an optical disk related to the invention in item (3) in which the recording layer is composed of a phase-change recording film that phase-changes reversibly between amorphous and crystalline states when being struck by a light beam to record and erase data.

(5) According to the present invention, there is provided an optical disk related to the invention in item (3) in which the numerical aperture of the objective is set to 0.65 and the thickness of the substrate is set to 0.3 mm.

(6) According to the present invention, there is provided, in a phase-change optical disk comprising:

a first phase-change recording film which phase-changes reversibly between amorphous and crystalline states when being struck by a light beam;

a first transparent substrate on which the first recording film is formed and has a thickness determined in the range from 0.2 mm to 0.4 mm;

a second phase-change recording film which phase-changes reversibly between amorphous and crystalline states when being struck by a light beam with the wavelength of blue near 410 nm; and

a first adhesive layer which joins the first transparent substrate to the first recording film positioned so that the first transparent substrate may face the incident side of the light beam in such a manner that the light beam passed through the first transparent substrate and first recording film is projected onto the second recording film,

a single-sided two-layer phase-change optical disk which enables the light beam from the incident side to be converged on one of the first and second phase-change recording films by an objective whose numerical aperture is selected from the range from 0.60 to 0.75 to record, erase, and reproduce data onto and from the recording film.

(7) According to the present invention, there is provided an optical disk related to the invention in item (6) in which the numerical aperture of the objective is set to 0.65 and the thickness of the substrate is set to 0.3 mm.

(8) According to the present invention, there is provided an optical disk according to claim 6 characterized by further comprising a phase-change optical disk including

a third phase-change recording film which phase-changes reversibly between amorphous and crystalline states when being struck by a light beam with the wavelength of blue near 410 nm,

a second transparent substrate on which the first recording film is formed and has a thickness determined in the range from 0.2 mm to 0.4 mm,

a fourth phase-change recording film which phase-changes reversibly between amorphous and crystalline states when being struck by a light beam, and

a second adhesive layer with a specific thickness which joins the second transparent substrate to the third recording film positioned so that the first transparent substrate may face the incident side of the light beam in such a manner that the light beam passed through the second transparent substrate and third recording film is projected onto the fourth recording film, wherein

the first transparent substrate is joined to the second transparent substrate and two single-sided two-layer phase-change disks are joined together to produce

a single-sided four-layer structure.

(9) According to the present invention, there is provided an optical disk related to the invention in item (8) in which the numerical aperture of the objective is set to 0.65 and the thickness of the substrate is set to 0.3 mm.

(10) According to the present invention, there is provided a method of reproducing data from an optical disk including a transparent substrate whose thickness is determined in the range of 0.2 mm to 0.4 mm and a recording layer which is formed on the transparent substrate and searched by the light beam passed through the transparent substrate, the method of reproducing data from the optical disk comprising:

the step of generating a light beam whose wavelength is selected from the range from 400 to 420 nm;

the step of converging the light beam on the recording film with an objective whose numerical aperture is determined in the range from 0.60 to 0.75; and

the step of processing the light beam from the recording film.

(11) According to the present invention, there is provided a reproducing method related to the invention in item (10) characterized in that the numerical aperture of the objective is set substantially to 0.65 and the thickness of the transparent substrate is set substantially to 0.3 mm.

(12) According to the present invention, there is provided a method of reproducing data from, recording data onto, or erasing data from an optical disk including a transparent substrate on which a light beam is projected and whose thickness is determined in the range of 0.2 mm to 0.4 mm and a recording layer which is formed on the transparent substrate and is searched, reproduced from, recorded into, or erased from by the light beam passed through the transparent substrate, the method of reproducing data from the optical disk comprising:

the step of generating a light beam with the wavelength of blue near 410;

the step of converging the light beam on the recording film with an objective whose numerical aperture is determined in the range from 0.60 to 0.75; and

the step of processing the light beam from the recording film.

(13) According to the present invention, there is provided a reproducing method related to the invention in item (12) characterized in that the recording layer is composed of a phase-change recording film that phase-changes reversibly between amorphous and crystalline states when being struck by a light beam to record and erase data.

(14) According to the present invention, there is provided a reproducing method related to the invention in item (12) characterized in that the numerical aperture of the objective is set to 0.65 and the thickness of the substrate is set to 0.3 mm.

(15) According to the present invention, there is provided a method of reproducing data from, recording data onto, or erasing data from a phase-change optical disk including

a first phase-change recording film which phase-changes reversibly between amorphous and crystalline states when being struck by a light beam,

a first transparent substrate on which the first recording film is formed and has a thickness determined in the range from 0.2 mm to 0.4 mm,

a second phase-change recording film which phase-changes reversibly between amorphous and crystalline states when being struck by a light beam, and

a first adhesive layer which joins the first transparent substrate to the first recording film positioned so that the first transparent substrate may face the incident side of the light beam in such a manner that the light beam passed through the first transparent substrate and first recording film is projected onto the second recording film, the method of reproducing data from the optical disk comprising:

the step of generating a light beam with the wavelength of blue near about 410;

the step of converging the light beam from the incident side on one of the first and second phase-change recording films with an objective whose numerical aperture is determined in the range from 0.60 to 0.75; and

the step of processing the light beam from the recording film.

(16) According to the present invention, there is provided a reproducing method related to the invention in item (15) characterized in that the numerical aperture of the objective is set to 0.65 and the thickness of the substrate is set to 0.3 mm.

(17) According to the present invention, there is provided an apparatus for reproducing data from an optical disk including a transparent substrate whose thickness is determined in the range of 0.2 mm to 0.4 mm and a recording layer which is formed on the transparent substrate and searched by the light beam passed through the transparent substrate, the apparatus for reproducing data:

means for generating a light beam whose wavelength is selected from the range from 400 to 420 nm;

means for converging the light beam on the recording film with an objective whose numerical aperture is determined in the range from 0.60 to 0.75; and

means for processing the light beam from the recording film.

(18) According to the present invention, there is provided a reproducing apparatus related to the invention in item (17) characterized in that the numerical aperture of the objective is set substantially to 0.65 and the thickness of the transparent substrate is set substantially to 0.3 mm.

(19) According to the present invention, there is provided an apparatus for reproducing data from, recording data onto, or erasing data from an optical disk including a transparent substrate on which a light beam is projected and whose thickness is determined in the range of 0.2 mm to 0.4 mm and a recording layer which is formed on the transparent substrate and is searched, reproduced from, recorded into, or erased from by the light beam passed through the transparent substrate, the apparatus for reproducing data from the optical disk comprising:

means for generating a light beam with the wavelength of blue near about 410;

means for converging the light beam on the recording film with an objective whose numerical aperture is determined in the range from 0.60 to 0.75; and

means for processing the light beam from the recording film.

(20) According to the present invention, there is provided a reproducing apparatus related to the invention in item (19) characterized in that the recording layer is composed of a phase-change recording film that phase-changes reversibly between amorphous and crystalline states when being struck by a light beam to record and erase data.

(21) According to the present invention, there is provided a reproducing apparatus related to the invention in item (19) characterized in that the numerical aperture of the objective is set to 0.65 and the thickness of the substrate is set to 0.3 mm.

(22) According to the present invention, there is provided an apparatus for reproducing data from, recording data onto, or erasing data from a phase-change optical disk including

a first phase-change recording film which phase-changes reversibly between amorphous and crystalline states when being struck by a light beam,

a first transparent substrate on which the first recording film is formed and has a thickness determined in the range from 0.2 mm to 0.4 mm,

a second phase-change recording film which phase-changes reversibly between amorphous and crystalline states when being struck by a light beam, and

a first adhesive layer which joins the first transparent substrate to the first recording film positioned so that the first transparent substrate may face the incident side of the light beam in such a manner that the light beam passed through the first transparent substrate and first recording film is projected onto the second recording film, the apparatus of reproducing data from the optical disk comprising:

means for generating a light beam with the wavelength of blue near about 410;

means for converging the light beam from the incident side on one of the first and second phase-change recording films with an objective whose numerical aperture is determined in the range from 0.60 to 0.75; and

means for processing the light beam from the recording film.

(23) According to the present invention, there is provided a reproducing apparatus related to the invention in item (22) characterized in that the numerical aperture of the objective is set to 0.65 and the thickness of the substrate is set to 0.3 mm.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a sectional view schematically showing the configuration of a single-sided two-layer RAM disk;

FIGS. 2A, 2B, and 2C are pictorial diagrams showing stains on the surfaces of optical disks related to a conventional equivalent and an embodiment of the present invention and a stain on the surface of an optical disk related to a comparative example;

FIG. 3 is a graph showing the relationship between the thickness of the transparent substrate and a coma occurring due to a disk tilt in a conventional equivalent and an embodiment of the present invention;

FIG. 4 is a graph showing the allowable range of the numerical aperture and thickness of the transparent substrate in an embodiment of an optical disk according to the present invention;

FIG. 5 is a graph showing an increase in the recording capacity expected as a result of increasing the numerical aperture in an optical disk under the setting conditions of FIG. 4;

FIG. 6 is a sectional view schematically showing the configuration of an optical disk according to an embodiment of the present invention;

FIG. 7 is a graph showing an increase in the recording capacity expected as a result of increasing the numerical aperture in a phase-change optical disk according to another embodiment of the present invention;

FIG. 8 is a sectional view schematically showing the configuration of a phase-change optical disk according to another embodiment of the present invention;

FIG. 9 is a sectional view schematically showing a first RAM layer disk before the laminating of the single-sided two-layer RAM disk of FIG. 8;

FIG. 10 is a sectional view schematically showing a second RAM layer disk before the laminating of the single-sided two-layer RAM disk of FIG. 8;

FIG. 11 is a block diagram showing a sputter unit for forming a film on a substrate to manufacture the first RAM layer and second RAM layer disks shown in FIGS. 9 and 10;

FIG. 12 is a block diagram showing an optical disk drive unit for driving a phase-change optical disk according to another embodiment of the present invention; and

FIG. 13 is a waveform diagram showing laser pulses during OW in the unit of FIG. 12.

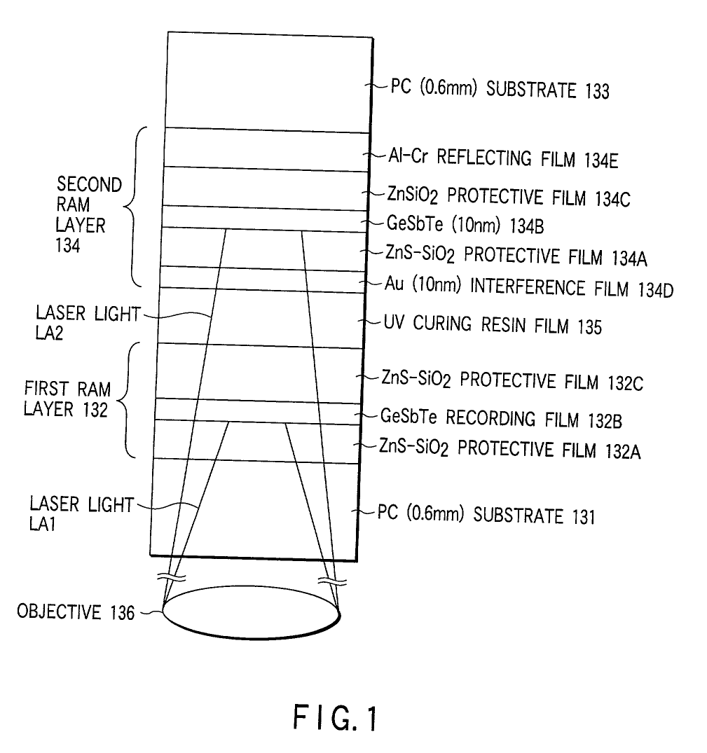

### DETAILED DESCRIPTION OF THE INVENTION

The basic idea of optimization in an optical disk, an information recording medium, according to the present invention will be explained below.

The larger the numerical aperture of an objective, the higher the recording density becomes, but at the same time, the recording density is more significantly affected by a disk tilt. To avoid this, the following thing can be considered: an objective is constructed with a numerical aperture a little smaller than the numerical aperture achievable at the present technological level, thereby making an early, stable improvement in the recording capacity relatively easily as compared with the present level, although as high a recording density as can be realized with the maximum numerical aperture cannot be expected. The embodiment of the invention is characterized in that the configuration of the objective is made that of a single lens, not a multi-lens configuration with many problems as described above, and the allowable amount of disk tilt is kept to the level allowed in the existing DVD system.

FIG. 3 is a graph showing the relationship between the thickness of the transparent substrate and a coma (converted into wave front aberration) occurring due to a disk tilt under each condition (or each numerical aperture of the objective). To make relative comparison, the amount of coma on the ordinate axis is set to an arbitrary unit. In the existing DVD-ROM, the thickness of the transparent substrate is 0.6 mm, the numerical aperture of the objective is 0.60, and the wavelength is 650 nm. With this DVD-ROM, when a disk tilt of a unit angle has occurred, the amount of coma occurred is about 200 in arbitrary units. Specifically, the coma can be estimated by the following proportional expression:

the amount of coma ∝t×(NA)³/λ (1)

where t is the thickness of the transparent substrate, NA is the numerical aperture of the objective, and λ is the wavelength of the light source.

It is seen from FIG. 3 that the wavelength changes from 650 nm to 410 nm and becomes shorter than that in the DVD-ROM and that making the numerical aperture larger causes a useless coma to increase. Since a coma increases in proportion to a disk tilt, the entire coma can be suppressed to a low level by manufacturing optical disks with a less tilt than before. In this case, however, the disk manufacturing cost increases, which leads to the disadvantage of increasing the selling price. This is incompatible with a goal to popularize high-density optical disk systems. To overcome this problem, it is necessary to take measures to suppress the effect of coma as much as possible, provided that the amount of tilt of the disk is at a conventional level.

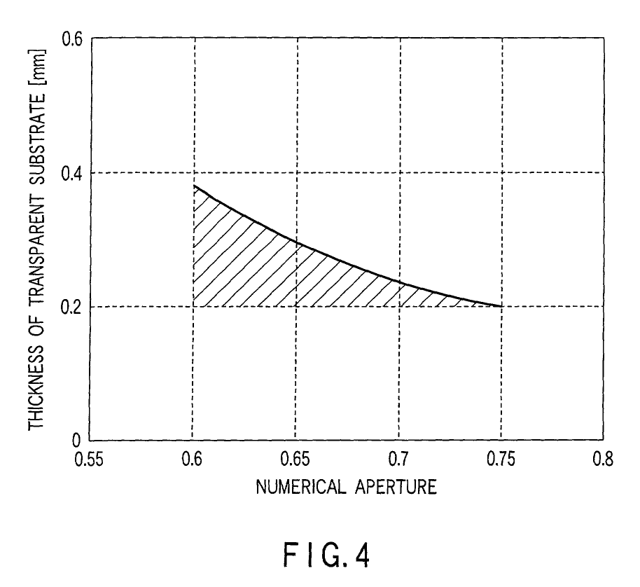

As seen from FIG. 3, to suppress the occurrence of a coma as large as that in a DVD-ROM system, the thinning of the transparent substrate and the limiting of the range of the numerical aperture must be combined. Specifically, it is necessary to set the numerical aperture to about 0.6 or more and 0.75 or less and the thickness of the transparent substrate to about 0.2 or more and 0.4 or less. In addition, all the combinations are not allowed in the range. The combinations of the thickness of the transparent substrate and the numerical aperture that can suppress a coma to a specific value or below are limited to the range shaded with slating lines shown in FIG. 4.

FIG. 5 shows the recording capacity estimated under such conditions. The actual recording capacity can be roughly estimated in preliminary examination, although the actual recording capacity is determined only after the minimum bit length and track pitch of an optical disk or a modulation method used in the drive system are designed and determined in detail and, on the basis of the determined factors, a basic experiment is done. FIG. 5 shows the storage capacities estimated in this way and plotted in a graph. FIG. 5 shows the calculated values of the capacity (the ordinate axis) on one side of a 120-mm-diameter optical disk with respect to the NA (the abscissa axis) of the objective when the laser wavelength is set to 410 nm. It is well known that the diameter of the condensed spot is decreased in proportion to the wavelength and in inverse proportion to the numerical aperture. Furthermore, since an increase in the recording density is almost proportional to the density (the way of packing) of pits in direction of radius and circumference of an optical disk, it is possible to estimate that an increase in the recording density is almost proportional to the square of the diameter of the condensed spot. That is, an increase in the recording density is expected to increase in proportion to the square of the wavelength and in inverse proportion to the square of the numerical aperture. FIG. 5 shows the result of calculating the recording capacity by proportional conversion on the basis of the existing DVD-ROM. As seen from FIG. 5, use of the proposed method is expected to realize a large capacity disk whose diameter is the same as that of a DVD-ROM disk and whose capacity is 12 to 18 GB per layer on one side.

An optical disk drive to which the present invention is applied has a basically similar configuration to what has been explained in, for example, Noboru Murayama, et al., “Optical Disk Technology,” Radio Gizyutusha, 1989. As described above, the optical disk drive of the invention differs from the latter only in the configuration of the objective and the wavelength of the light source. The remaining configuration is the same as that of the latter. Since the system of a RAM disk drive explained later has basically the same configuration as that of a drive unit for the above-described optical disk, the explanation should be referred to for an outline of the system of an optical disk drive to which the above embodiment is applied.

As described above, in the embodiment, like a conventional objective with a numerical aperture of 0.6 or less, the objective is a single lens and is fixed in a specific position on the lens actuator. The numerical aperture is 0.65. The objective is not restricted to the single lens and may be a composite lens consisting of a plurality of lenses, provided that they are inexpensive and highly reliable.

The light source is a semiconductor laser whose wavelength is 400 nm and used in basically the same manner as a conventional red semiconductor laser or an infrared semiconductor laser. According to the wavelength of the light source, the best coating specifications for optical component parts, including prisms and lenses, are selected.

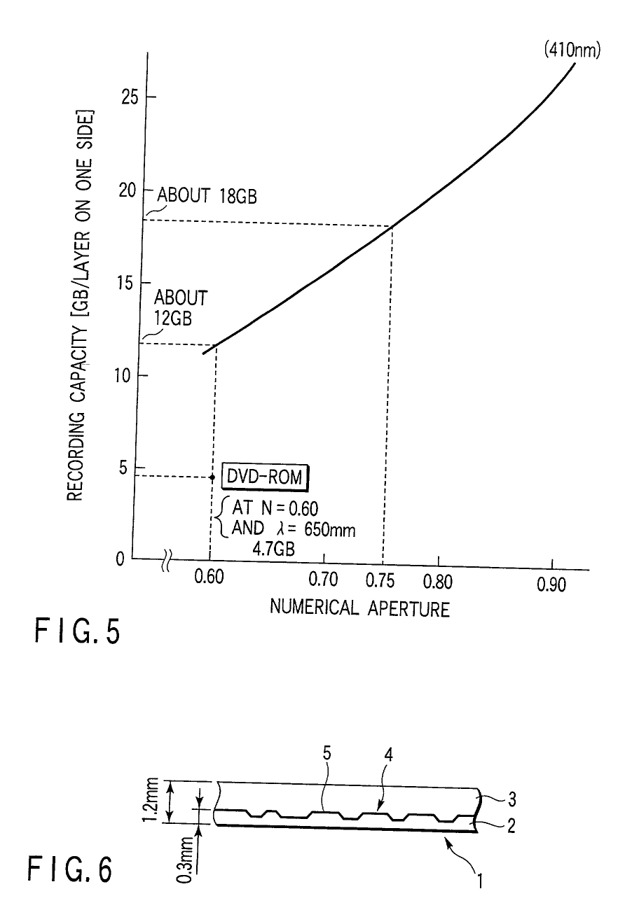

The configuration of an optical disk (ROM optical disk) according to a concrete embodiment of the present invention is shown in FIG. 6. An optical disk 1 shown in FIG. 6 is composed of a transparent substrate 2 and a PC (polycarbonate) substrate 3. In the PC substrate 3, pits carrying information have been formed beforehand as in the substrate of a playback-only disk, such as a CD. The thickness of the PC substrate 3 has been set to 0.9 mm. To increase the reflectivity, for example, an aluminum thin film 5 is deposited on the pit 4 side of the PC substrate 3 by vacuum vapor deposition. Furthermore, on the pit side of the PC substrate 3, a 0.3-mm-thick transparent substrate 2 has been formed. Specifically, on the aluminum-deposited PC substrate 3, a 0.3-mm-thick ultraviolet-curing resin layer is formed by the spin coating method, or a 0.3-mm-thick transparent sheet is formed from adhesive or ultraviolet-curing self-adhesive, thereby forming the transparent substrate 2. These techniques have been established as the DVD-ROM disk laminating technique.

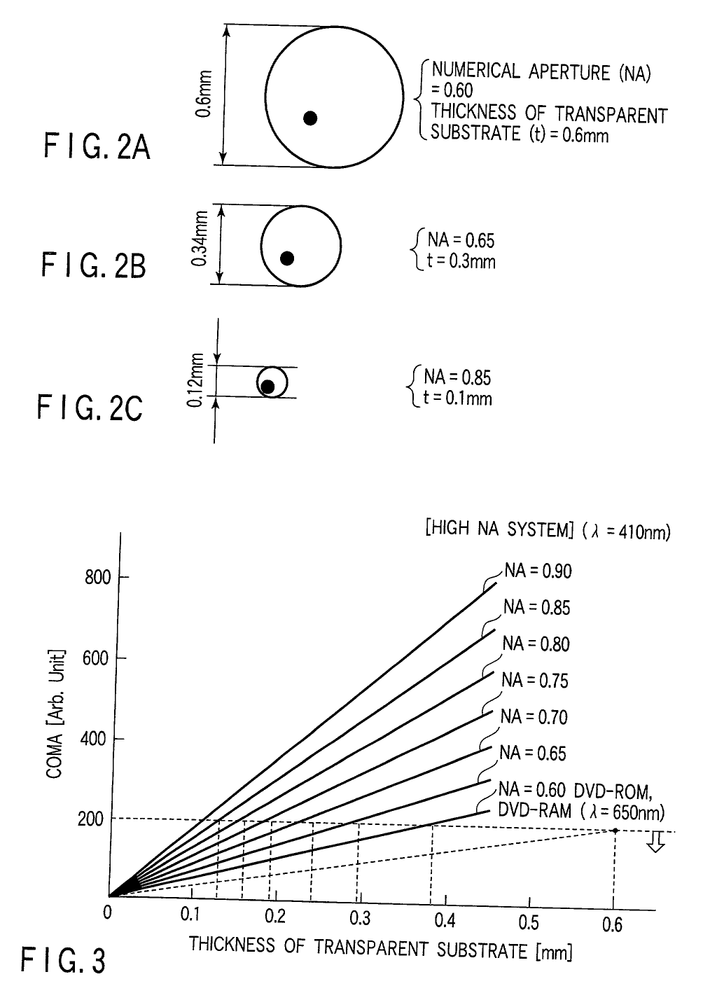

In the optical disk with the above configuration, the diameter of the light beam at the disk surface is about 0.34 mm as shown in FIG. 2B, which relatively alleviates the effect of stains on the surface. The operating distance is about 1.7 mm, which makes it possible to design the servo system, taking measures to prevent a collision between the objective and the disk.

Next, a phase-change optical disk according to another embodiment of the present invention, particularly a single-sided two-layer RAM disk, will be explained by reference to FIGS. 6 to 13.

A phase-change optical disk according to another embodiment of the present invention is subjected to optimization, taking into account advantages and disadvantages in making the capacity of the phase-change optical disk larger. Specifically, the wavelength of the semiconductor laser is set in the wavelength of blue near 410 nm, the NA of the objective is set larger than 0.6 and smaller than 0.75, and the thickness of the substrate is set larger than 0.2 mm and smaller than 0.4 mm. Such optimization makes it possible to provide a phase-change optical disk capable of not only high-density recording but also single-sided two-layer RAM design. Specifically, with the present invention, a blue laser with a wavelength of 410 nm is used, an objective with an NA of 0.65 is used, and 0.3-mm-thick round disks are used to form a single-sided two-layer phase-change RAM disk. Two single-sided two-layer disks are laminated together, with the laser indecent side facing outward, thereby forming a four-layer RAM disk as a whole including both sides, which makes it possible to make the entire thickness almost 1.2 mm even in the case of a 130-mm-diameter disk. This achieves at least the same mechanical accuracy or stiffness of that of the existing single CD (1.2 mm in thickness) or double-sided laminated DVD (1.2 mm in thickness after laminating).

With this disk, a recordable/reproducible/erasable user capacity of about 12 GB can be secured using a single-sided one-layer disk, that of about 24 GB can be secured using a single-sided two layer disk, and that of about 48 GB can be secured using a double-sided four-layer disk.

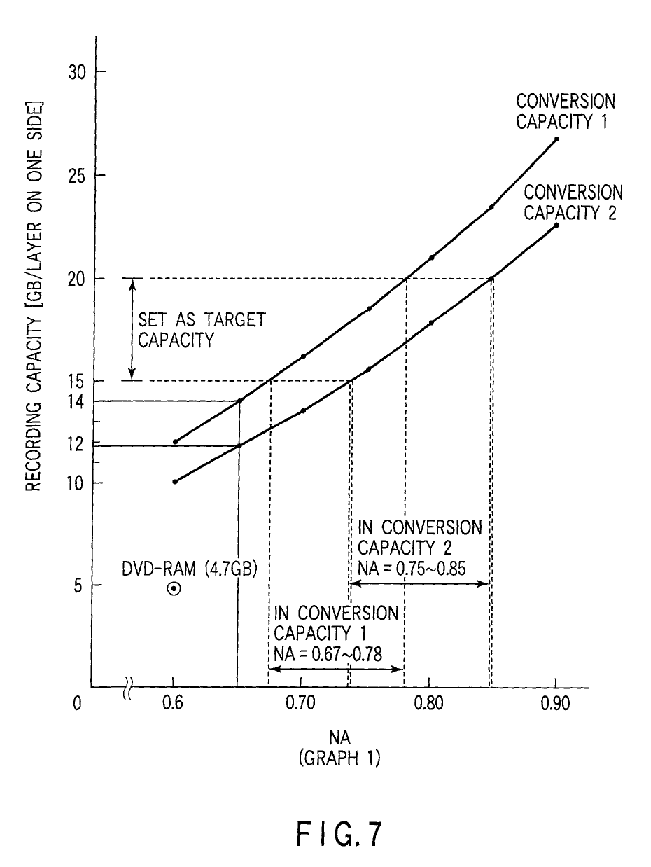

Optimization of a single-sided two-layer phase-change RAM disk as described above will be explained by reference to the graph of FIG. 7 similar to FIG. 5.

FIG. 7 shows the calculated values of the capacity (the ordinate axis) on one side of a 120-mm-diameter optical disk with respect to the NA (the abscissa axis) of the objective when the laser wavelength is set to 410 nm. Conversion capacity 1 was calculated on the basis of the second-generation DVD-RAM whose standardization is now in progress. Here, the second-generation DVD-RAM is a 120-mm-diameter disk with a phase-change recording film. The user capacity on its one side is 4.7 GB, the laser wavelength λ is 650 (λr), the NA of the objective is 0.6 (NAr), and the thickness of the substrate is 0.6 mm. Under these conditions, with the capacity, the capacity on one side is calculated in a case where the laser wavelength is changed from 650 nm (λr) to 410 nm (λb) and the NA of the objective is changed from 0.6 (NAr) to a higher NA (NAb). The calculation is simple. The ratio of the wavelength of the laser to the NA of the objective is found and the face density (in other words, the capacity on one side) is the square of the ratio and large, which is expressed by equation (2):

Conversion capacity 1=4.7×{(λr/λb)/(NAr/NAb)}² (2)

where NAr 0.60, NAb=a variable, a parameter, λr=650 nm, and λb=410 nm.

Furthermore, conversion capacity 2 represented by the following equation (3) is an example of converting the capacity in a case where the recording density is eased leaving a little leeway because a crosstalk between the data on the first RAM layer disk and the data on the second RAM layer disk is expected:

Conversion capacity 2=conversion capacity 1×0.844 (3)

It is seen from conversion capacity 1 that, when the laser wavelength is changed from 650 nm to 410 nm and the capacity on one side is changed from 15 GB to 20 GB, the NA of the objective changes from 0.67 to 0.78. In this case, however, since a 0.1-mm-thick substrate must be used as described above, a single-sided two-layer RAM disk cannot be realized.

In addition, it is seen that use of conversion capacity 2 enables the user capacity on one side of a 120-mm-diameter disk to be 12 GB, provided that a single-sided two-layer RAM is used and the NA of the objective is NA=0.65 at which manufacturing is easily done using ordinary manufacturing technology and low purchase prices are possible.

Next, the result of examination of coma is shown in FIG. 3 and equation (1). As explained earlier, FIG. 3 shows a coma, with the thickness of the substrate on the abscissa axis, when the wavelength is 410 nm and the NA of the objective is used as a parameter. The coma is represented by equation (1). For reference, the case of a 4.7-GB DVD-RAM (with a wavelength of 650 nm) is indicated by dotted lines. When the coma is assumed to be about 200 almost the same as that of the existing 4.7-GB DVD-RAM, the thickness of the substrate is determined uniquely when the NA is changed using a laser whose wavelength is 410 nm. When the NA is set to 0.85 or 0.9, the thickness of the substrate becomes close to 0.1 mm as described earlier. On the other hand, when the NA of the objective is assumed to be 0.65 at which manufacturing is easy and the purchase price is low, it becomes clear that the thickness of the substrate is preferably 0.3 mm. A 0.3-mm-thick substrate can be produced by injection molding of resinous material in the same manner as before. Then, a single-sided two-layer RAM has a thickness of about 0.6 mm. Furthermore, two single-sided two-layer disks are laminated together, with the substrate side (the laser indecent side) facing outward, which makes the thickness 1.2 mm. This enables the thickness to be set to the same thickness as that of the existing CD or that of a two-disk-laminated DVD, which provide a sufficient mechanical accuracy and mechanical strength from the viewpoint of products.

As explained above, when a laser with a wavelength of 410 nm is used, the NA of an objective is set to 0.60 to 0.75 at which the objective is easy to manufacture and is available at low price, and the thickness of the substrate is set to 0.2 mm to 0.4 mm so as to suppress a coma to almost that of the existing DVD-RAM, the capacity can be made very large. In addition, single-sided two-layer RAMs are laminated together to form a four-layer disk, thereby achieving a sufficient mechanical accuracy.

As described above, a commercially feasible double-sided four-layer RAM disk, two layers on one side, can be realized by using a blue laser, setting the thickness of the substrate to a midpoint between 0.6 mm and 0.1 mm, and making the NA of the objective a little larger than that of the existing DVD. In other embodiments explained below, a case where the thickness of the substrate is set to 0.3 mm, the NA of the objective is set to 0.65, and recording and reproducing are done using a blue layer with a wavelength of 410 nm will be explained as a typical example.

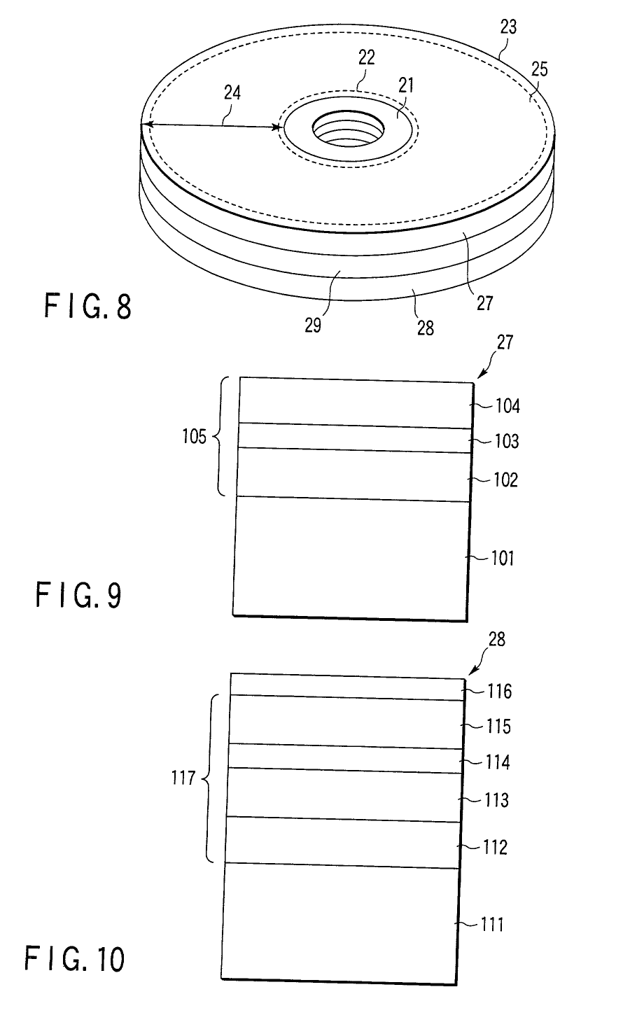

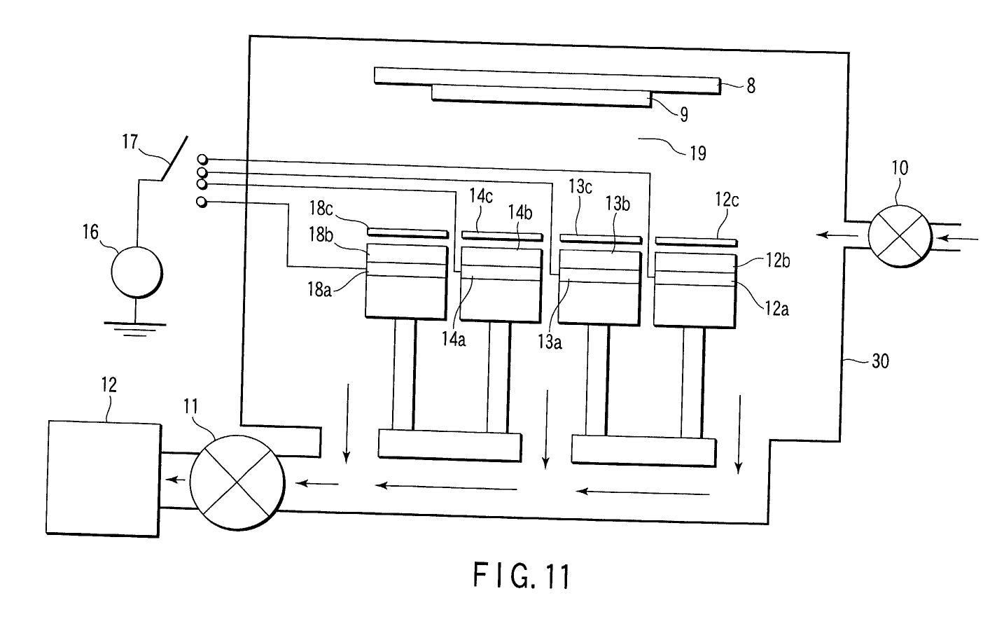

FIG. 8 is a perspective view of an optical disk according to another embodiment of the present invention. FIGS. 9 and 10 are sectional views schematically showing the configuration of the optical disk of FIG. 8.

As shown in FIG. 8, the single-sided two-layer optical disk has a configuration where a disk 27 with a first RAM layer (hereinafter, just referred to as the first-RAM-layer disk 27) and a disk 28 with a second RAM layer (hereinafter, just referred to as the second-RAM-layer disk 27) are joined together with a UV curing resin film 29 acting as a joining layer. In the center of the disk, there is a hole through which a spindle connected to the rotating motor of a disk drive. Around the hole, there is provided a clamping area 21 for clamping the optical disk in such a manner that the disk can be rotated. In the inner zone around the periphery of the clamping area 21, a lead-in area 22 where the pickup head (not shown) starts to search for data is provided. In the outer zone, a lead-out area 23 is provided. The space from the lead-in area 21 to the lead-out area 23 is set as an information recording area 24 in which information is recorded. The area between the lead-in area 22 and the lead-out area 23 is set as a data write area 25 in which data is written.

As shown in FIG. 3, the first-RAM-layer disk 27 has a configuration where a ZnS—SiO₂ protective film 102, a GeSbTe phase-change recording film 103, a ZnS—SiO₂ protective film 104 are stacked on a 0.6-mm-thick disk-like polycarbonate substrate 101 in that order. The ZnS—SiO₂ protective films 102 and 104 are compound films composed of the compound materials ZnS and SiO₂ (hereinafter, just referred to as the ZnS—SiO₂ protective films). Since the transmittance of the first RAM layer 105 composed of the protective layer 102, phase-change recording film 103, and protective film 104 is set to 50%, a metal reflecting film that should be provided in an ordinary one-layer phase-change optical disk is not provided in the first RAM layer 105.

As shown in FIG. 4, the second-RAM-layer disk 28 has the following configuration: on a 0.6-mm-thick polycarbonate transparent substrate, an Al—Cr reflecting film 112 and a dielectric protective film 113 composed of a ZnS—SiO₂ compound film are formed. On the resulting film, a phase-change recording film 114 is formed which is composed of, for example, GeSbTe ternary alloy that phase-changes reversibly between the amorphous and crystalline states when being hit by, for example, a laser beam. On the recording film 114, a dielectric protective film 115 composed of a ZnS—SiO₂ compound film and further an Au translucent film 116 serving as a translucent interference film to form an L-to-H medium are formed in that order. Here, the ZnS—SiO₂ protective films 113, 115 are also compound films composed of the compound materials ZnS and SiO₂ (hereinafter, just referred to as the ZnS—SiO₂ protective films).

The phase-change recording film 114 is made amorphous by projecting a laser beam on the film to melt the film and cooling the film rapidly. At this time, the dielectric protective films 113 and 115 have the function of preventing the recording film 114 from evaporating and having a hole in it, that is, the function of protecting the recording film from heat. The upper dielectric layer 115 is designed to be enhanced optically in signal playback by multiplier effect of the Au translucent layer 116 and metal reflecting layer 112. The thickness of the upper dielectric layer 115 is normally set to 500 Å to 3000 Å. The phase-change recording film 114 is normally designed to be very thin so that it may be melted by the projection of the laser beam. Its thickness is set to 50 Å to 300 Å. The dielectric protective film 113 under the phase-change recording film 114 is required to have such a structure as lets heat escape to the metal reflecting film 112 in order to rapidly cool the heat at the recording layer melted by the projection of the laser beam to make the layer amorphous. The dielectric protective film 113 is thin and typically set to a thickness ranging from about 50 Å to 300 Å.

Since the recent increase in the data transfer speed requires high-speed recording, a phase-change optical disk of the decooling (retaining heat) type, not the rapidly cooling (heat dispersing) type, has been studied to improve the sensitivity of the disk. In this case, the lower dielectric layer 113 is set to 300 Å to 3000 Å. To enhance the playback signal and make it easier for heat to escape, the thickness of the metal reflecting film 112 is normally set to about 500 Å to 3000 Å.

In the present embodiment, since the recording sensitivity is set much higher than usual, there may be a case where heat has to be made difficult to escape. In that case, the thickness of the metal reflecting film may be set to 100 Å to 500 Å. To cause the laser beam passed through the Au film to interfere with the reflected light beam from the recording film 114 for enhancement, the Au translucent film 116 requires suitable transmission and reflection. Its film thickness is normally set to 20 Å to 200 Å.

To set a single-sided 12-GB user capacity, high-density recording is done with a linear density 2.553 times the existing 4.7-GB per side. To covert this into the linear density, the square root is found, giving 1.6 times. Since the track pitch of the existing 4.7-GB RAM disk is 0.6 μm, the track pitch of a 12-GB disk is 0.375 μm.

Hereinafter, a method of producing a single-sided two-layer RAM disk according to another embodiment of the present invention will be explained by reference to FIG. 11.

FIG. 11 shows a sputter unit which produced a single-sided two-layer RAM disk according to another embodiment of the present invention.

(Embodiment)

On a rotating disk-like table 8 shown in FIG. 11, a 120-mm-diameter, 0.3-mm-thick polycarbonate disk substrate in whose surface 0.375-μm-wide continuous grooves had been formed was set. Then, a vacuum sputter unit 30 was evacuated to a vacuum of 10⁻⁶ torr by a vacuum turbo pump 12. In the figure, numeral 11 indicates a valve in the evacuation system.

First, the first-RAM-layer disk of FIG. 9 was produced. With the rotating table 8 being rotated at 60 rpm, an Ar gas intake valve was opened and Ar gas was introduced into the sputter unit. With the capability of the evacuation system remaining unchanged, the flow of the Ar gas was adjusted by a mass flow controller (not shown) so as to set the vacuum level in the unit to 5×10⁻³ torr. An RF power supply 16 was switched by a selector switch 17 to the electrode 13a side of a ZnS/SiO₂ target 13b, with the result that the RF power 600 W was supplied to the ZnS/SiO₂ target. After about one minute of presputter, a shutter 13c just above the target was opened and the formation of a ZnS/SiO₂ dielectric film was started on a substrate 9. After five minutes had elapsed since the start of the film formation, the RF power supply 16 was turned off and the shutter 13c was closed. On the substrate 9, the ZnS/SiO₂ film was formed to a thickness of 510 Å.

After the valve 10 was closed and the remaining Ar gas and ZnS/SiO₂ molecules in the unit were exhausted once via the evacuation system, the valve 10 was opened again to introduce Ar gas and the Ar gas pressure in the sputter unit was set to 5×10⁻³ torr. The selector switch 17 was switched to the electrode 14a side of a GeSbTe compound target 14b and the power supply 16 was turned on, with the result that 200 W of power was supplied to the GeSbTe target. After about one minute of presputter, a shutter 14c just above the target was opened and the formation of a GeSbTe phase-change recording film on the ZnS/SiO₂ protective film was started. After 15 seconds had elapsed since the film formation, the RF power supply 16 was turned off and a 70-Å-thick GeSbTe recording film was formed on the ZnS—SiO₂ film. Then, after the valve 10 was closed again and the remaining Ar gas and GeSbTe molecules in the sputter unit were evacuated, the valve 10 was opened to introduce Ar gas. After the gas flow was adjusted so that the Ar gas pressure became 5×10³ torr, the selector switch 17 was connected again to the electrode 13a side of the ZnS—SiO₂ target 13b, with the result that the RF power supply 16 supplied 600 W of power to the ZnS—SiO₂ target 13b. After about one minute of presputter, the shutter 13c was opened again and the formation of a ZnS/SiO₂ film was started. After eight minutes had elapsed since the film formation, the RF power supply 16 was turned off to close the shutter 13c and a 800-Å-thick ZnS—SiO₂ dielectric film was stacked on a Ge₂Sb₂Te₅ recording film.

Then, the sample disk 9 was taken out of the sputter unit 30. In the first-RAM-layer disk, the film structure includes the substrate, a ZnS—SiO₂ film (510 Å), a GeSbTe recording film (70 Å), and ZnS—SiO₂ (800 Å). The first-RAM-layer disk was put in an initial crystallization unit (not shown), which crystallized the entire surface of the disk with a high-power Ar laser. Thereafter, a laser beam with a wavelength of 410 nm was projected from the substrate side and the reflectivity was measured. The measurement showed that the reflectivity from the crystalline part was about 8%. In completely the same manner, another first-RAM-layer disk was produced.

Next, the two-layer disk shown in FIG. 10 was produced. As with the first-RAM-layer disk, on the rotating table 8 in the vacuum sputter unit 30, a 130-mm-diameter, 0.3-mm-thick polycarbonate disk substrate at whose surface continuous grooves with a track pitch of 0.375 μm have been formed was set. Thereafter, the vacuum sputter unit 30 was evacuated to a vacuum of 10⁻⁶ torr by the vacuum turbo pump 12. With the rotating table 8 being rotated at 60 rpm, the Ar gas intake valve 10 was opened and Ar gas was introduced into the sputter unit. With the capability of the evacuation system kept unchanged, the flow of the Ar gas was adjusted by the mass flow controller (not shown) so as to set the vacuum level in the unit to 5×10³ torr. The selector switch 17 was switched to the electrode 15a side of an AlCr target 15b, with the result that the RF power supply 16 supplied 200 W of power to the AlCr target 15b. After about one minute of presputter, a shutter 15C was opened and the formation of an AlCr reflecting film was started. After 50 seconds had elapsed since the start of the film formation, the RF power supply was turned off and the shutter 15C was closed. On the substrate, the AlCr film was formed to a thickness of 300 Å. After the remaining Ar gas and AlCr alloy atoms were exhausted once via the evacuation system 12, the valve 10 was opened again to introduce Ar gas into the sputter unit and the mass flow controller (not shown) was adjusted so as to set the vacuum level in the sputter unit to 5×10⁻³ torr. Thereafter, the selector switch 17 was switched to the electrode 13a side of the ZnS—SiO₂ target 13b, with the result that 600 W of RF power was supplied to the ZnS—SiO₂ target. After about one minute of presputter, the shutter 13c just above the target was opened and the formation of a ZnS—SiO₂ dielectric film on the substrate 9 was started. After five minutes 30 seconds had elapsed since the film formation, the RF power supply 16 was turned off and the shutter 13c was also closed. On the AlCr film, a ZnS—SiO₂ film was formed to a thickness of 550 Å. Then, after the valve 10 was closed and the remaining Ar gas and ZnS—SiO₂ molecules in the unit were evacuated once. Thereafter, the valve 10 was opened again to introduce Ar gas and the Ar gas pressure in the sputter unit was set to 5×10⁻³ torr. Then, the selector switch 17 was switched to the electrode 14a side of the GeSbTe compound target 14b, with the result that the power supply 16 was turned on and 600 W of power was supplied to the GeSbTe target. After about one minute of presputter, the shutter 14c just above the target was opened again and the formation of a GeSbTe phase-change recording film was started. After 20 seconds minutes had elapsed since the film formation, the RF power supply 16 was turned off and a 100-Å-thick GeSbTe recording film was formed on a ZnS—SiO₂ film. Then, the valve 10 was closed again and the remaining Ar gas and GeSbTe molecules in the sputter unit were evacuated. Thereafter, the valve 10 was opened to introduce Ar gas into the sputter unit 30. After the gas flow was adjusted so that the Ar gas pressure became 5×10⁻³ torr, the selector switch 17 was switched again to the electrode 13a side of the ZnS—SiO₂ target 13b, with the result that the RF power supply 16 supplied 600 W of power to the ZnS—SiO₂ target 13b. After about one minute of presputter, the shutter 13c was opened again and the formation of a ZnS/SiO₂ film was started. After ten minutes 20 seconds had elapsed since the film formation, the RF power supply 16 was turned off to close the shutter 13C and a 1040-Å-thick ZnS—SiO₂ dielectric film was stacked on a GeSbTe recording film. Finally, the valve 10 was closed again and the remaining Ar gas and ZnS—SiO₂ molecules in the unit were evacuated. Thereafter, the valve 10 was opened to introduce Ar gas. After the Ar gas pressure was set to 5×10⁻³ torr, the selector switch 17 connected the RF power supply 16 to the electrode 12b provided under the Au target 12b, with the result that the RF power supply 16 supplied 150 W of RF power at 13.56 MHz and sputtering of the Au target is started using Ar gas. After about one minute of presputter, the shutter 12c just above the target was opened and a 100-Å-thick Au optical interference film was formed on the ZnS/SiO₂. Then, the RF power supply was turned off and the shutter 12c was closed.

Then, the second-RAM-layer sample disk 9 produced in the normal process was taken out of the sputter unit 30. In the above explanation, the film structure of the disk includes the substrate, AlCr (300 Å), ZnS—SiO₂ (550 Å), GeSbTe (100 Å), ZnS—SiO₂ (1000 Å), and Au (100 Å). The second-RAM-layer disk was also put in the initial crystallization unit (not shown), which crystallized the entire surface of the disk. Thereafter, the reflectivity was measured using a semiconductor laser beam with a wavelength of 410 nm. The measurement showed that the reflectivity from the crystalline part was about 13%.

In completely the same manner, another second-RAM-layer disk was produced. The second-RAM-layer disks and the first-RAM-layer disks produced in the above embodiment were laminated together with a UV curing resin in such a manner that they formed a single-sided two-layer RAM disk as shown in FIG. 8. A 40-μm-thick UV curing resin was applied uniformly by a spinner (not shown) to the entire surface of the ZnS—SiO₂ film on the first-RAM-layer disk. Thereafter, the second-RAM-layer disk was laid on the first-RAM-layer in such a manner that the Au interference film side of the second-RAM-layer disk made contact with the UV resin. Then, 800 W of UV light was projected for 20 seconds from the substrate side of the first-RAM-layer disk, thereby curing the UV resin.

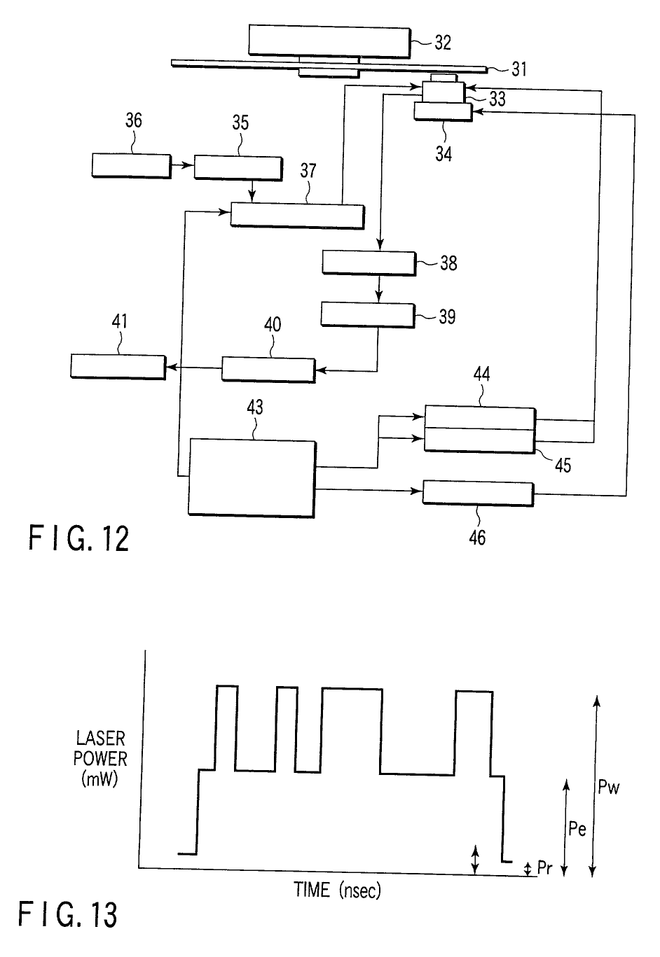

Since two units of each of the first-RAM-layer disk and second-RAM-layer disk were produced, two single-sided two-layer RAM disks were produced as a result of lamination. Their performance was evaluated by putting the experimentally produced phase-change optical disk samples on an optical disk drive unit shown in FIG. 12.

First, the optical disk drive unit of FIG. 12 will be explained. The sample disk 31 is rotated by a spindle motor 32 to a specific number of revolutions. Because the sample disk was assumed to be a single-sided two-layer DVD-RAM, the constant linear-velocity system where the number of revolutions is changed gradually according to the position on the radius of the disk was used so that the relative speed between the disk 31 and optical head 33 might be at 8.2 m/s constantly. An input unit 36 inputted a specific signal, which was digitized by a modulation circuit 35 into signals of 1 or 0 by 8/16 modulation in the case of, for example, DVD-RAM. The modulated digital signal was sent to a laser driver 37, which turned on and off the laser of the optical head, thereby writing the data onto the disk sample 31. Since no blue semiconductor laser has been put on the market, an Ar gas laser with a wavelength of 414 nm was provided in place of the semiconductor blue laser. An objective with a NA of 0.65 was used. In the case of a phase-change optical disk, as shown in FIG. 13, the laser power was raised (to power Pw) for the part to be recorded into, thereby melting the recording film and cooling rapidly the film, which brought the film into the amorphous state. For the part from which the data was to be erased, the laser power was set to the medium level (laser power Pe), raising the erased part of the recording film to the crystallizing temperature or above to crystallize the part. Here, the laser power Pr is playback power during playback. Since the data (amorphous mark) written on the sample disk has a different reflectivity from that of the surrounding crystallized part, scanning a constant low power disk enables a signal to be sensed in the form of a difference in the amount of reflected light. The reproduced signal is amplified by a preamplifier 38. A binarization circuit 39 converts the analog signal into a digital signal of 1 and 0. Furthermore, a demodulation circuit 40 demodulates the digital signal through 8/16 modulation into an analog signal and outputs the analog signal to an output unit 41. In FIG. 12, numeral 43 indicate a servo control system, which controls a laser driver 37 in recording with laser. In recording or reproducing, for example, a linear motor 34 accesses a specific position on the radius in a linear motor driving control system under the control of a control system. Furthermore, under the control of a focus driving control system 44 and a track driving control system 45, the objective actuator provided on the optical head 33 is controlled in such a manner that it follows the rolling of surface of the disk or the decentering of the track in recording or reproducing.

Next, a method of evaluating the sample disk will be explained. To give a 12-GB user capacity per side to each of the first and second layers of the single-sided two-layer RAM disk, the recording density must be increased to 1.6 times the present linear density. Because the track pitch has been set to 0.375 μm, it is increased to the same level as that of the bit pitch. Since the pit pitch for 4.7 GB per side is 0.28 μm, recording has to be done with a pitch of 0.175 μm. To measure the playback C/N ratio (Carrier to Noise Ratio) later, the formation of only the shortest mark 3T requires recording to be done at a frequency of 20.8 MHz with a 50% duty. The C/N ratio is measured with a spectrum analyzer in playback after recording. On the basis of the measurement, the magnitude of the playback signal can be evaluated.

In evaluation, to examine the mechanical strength of a disk with a thickness of about 0.6 mm produced by laminating two 0.3-mm-thick disks together, a first judgment was made, depending on whether focus servo functioned following the rolling of the surface at the outer edge of the disk put on the drive unit (the acceleration of rolling of the surface when the disk was rotated at a linear velocity of 8.2 m/second). Actually, in the 0.6-mm-thick single-sided two-layer RAM disk, focus servo functioned on the inner edge side, but it did not function on the outer edge side.

Next, two single-sided two-layer RAM disks were laminated together in such a manner that the second-RAM-layer disks lay inside. In this case, because a UV curing resin adhesive would prevent UV light from reaching the adhesive after application, double-sided tape was used for bonding. It goes without saying that the total thickness of the single-sided two-layer RAM, double-sided four-layer RAM disk was about 1.2 mm. In the four-layer disk, the first-RAM-layer disk and second-RAM-layer disk of one single-sided two-layer RAM was brought into focus and the servo was applied. As a result, the servo functioned immediately on both of the first-RAM-layer disk and second-RAM-layer disk. Thus, it became clear that the 1.2-mm-thick double-sided disk had no mechanical strength problem as expected. Then, when recording was done with a 20.8-MHz duty ratio of 50%, the recorded signal was reproduced with a 1-mW playback light, and the C/N ratio was measured, and when recording was done with the recording power Pw set to 8 mW and the erasing power Pe set to 4 mW for both of the first-RAM-layer disk and second-RAM-layer disk, the playback C/N ratio was 53 dB for both of the first-RAM-layer disk and second-RAM-layer disk. Then, the disk was turned over and the same shortest mark was recorded on the two-layer disk on the other side. Then, the playback C/N ratio was measured, giving the same result.

In the embodiment of the phase-change optical disk according to the present invention, the case where a blue laser with a wavelength of 410 nm is used with the thickness of the substrate being 0.3 mm and the NA of the objective being 0.65 has been explained. When a laser with a wavelength of 410 nm is used, the NA of the objective is set to 0.60 to 0.75 at which the objective is relatively easy to manufacture and available at low price, and the thickness of the substrate is set to 0.2 mm to 0.4 mm so that coma may be limited to almost that of the existing DVD-RAM, it is possible to make the capacity of the disk much larger. It is easily expected that laminating four disks of single-sided two-layer RAM together produces sufficient mechanical accuracy.

While in the embodiments of the invention, a phase-change recording film that phase-changes reversibly between the amorphous state and the crystalline state has been used as a rewritable recording medium, the present invention is not restricted to the recording medium. For instance, the invention may be applied to a magneto-optical recording film. It goes without saying that this application produces the same effect.

An optical disk according to the present invention is such that the thickness of the transparent substrate is selected from the range from 0.2 mm to 0.4 mm, the wavelength of the light beam passing through the transparent substrate is selected from the range of 400 nm to 420 nm, the numerical aperture of the objective for converging the light beam is selected from the range from 0.60 to 0.75, and the signal playback characteristic deteriorates less due to stains on the disk surface. Thus, neither the cost of component parts nor the assembly cost in manufacturing an optical head using the objective increases. Furthermore, it is easier to secure not only the reliability of the objective but also a sufficient operating distance.

With another embodiment of a phase-change optical disk according to the present invention, the case where a blue laser with a wavelength of 410 nm is used with the thickness of the substrate being 0.3 mm and the NA of the objective being 0.65 has been explained. When a laser with a wavelength of 410 nm is used, the NA of the objective is set to 0.60 to 0.75 at which the objective is relatively easy to manufacture and available at low price, and the thickness of the substrate is set to 0.2 mm to 0.4 mm so that coma may be limited to almost that of the existing DVD-RAM, it is possible to make the capacity of the disk much larger. Furthermore, laminating four disks of single-sided two-layer RAM together produces sufficient mechanical accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk comprising:
a transparent substrate on which a light beam which is converged by an objective whose numerical aperture is determined in the range from 0.60 to 0.75 and whose wavelength is selected from the range from 400 to 420 nm is projected and whose thickness is determined in the range of 0.2 mm to 0.4 mm; and
a recording layer which is formed on the transparent substrate and searched by the light beam passed through said transparent substrate.

2. An optical disk comprising:
a transparent substrate on which a light beam which is converged by an objective whose numerical aperture is determined in the range from 0.60 to 0.75 and has the wavelength of blue near about 410 nm is projected and whose thickness is determined in the range of 0.2 mm to 0.4 mm; and
a recording layer which is formed on the transparent substrate and which is searched, reproduced from, recorded into, or erased from by the light beam passed through said transparent substrate.

3. In a phase-change optical disk comprising:
a first phase-change recording film which phase-changes reversibly between amorphous and crystalline states when being struck by a light beam;
a first transparent substrate on which the first recording film is formed and has a thickness determined in the range from 0.2 mm to 0.4 mm;
a second phase-change recording film which phase-changes reversibly between amorphous and crystalline states when being struck by a light beam with said wavelength of blue near 410 nm; and
a first adhesive layer which joins said first transparent substrate to said first recording film positioned so that said first transparent substrate may face the incident side of the light beam in such a manner that the light beam passed through said first transparent substrate and first recording film is projected onto said second recording film,
a single-sided two-layer phase-change optical disk which enables said light beam from said incident side to be converged on one of the first and second phase-change recording films by an objective whose numerical aperture is selected from the range from 0.60 to 0.75 to record, erase, and reproduce data onto and from the recording film.

4. A method of reproducing data from an optical disk including a transparent substrate whose thickness is determined in the range of 0.2 mm to 0.4 mm and a recording layer which is formed on the transparent substrate and searched by the light beam passed through said transparent substrate, said method of reproducing data from the optical disk comprising:
the step of generating a light beam whose wavelength is selected from the range from 400 to 420 nm;
the step of converging the light beam on said recording film with an objective whose numerical aperture is determined in the range from 0.60 to 0.75; and
the step of processing the light beam from the recording film.

5. A method of reproducing data from, recording data onto, or erasing data from an optical disk including a transparent substrate on which a light beam is projected and whose thickness is determined in the range of 0.2 mm to 0.4 mm and a recording layer which is formed on the transparent substrate and is searched, reproduced from, recorded into, or erased from by the light beam passed through the transparent substrate, said method of reproducing data from the optical disk comprising:
the step of generating a light beam with the wavelength of blue near 410;
the step of converging the light beam on said recording film with an objective whose numerical aperture is determined in the range from 0.60 to 0.75; and
the step of processing the light beam from the recording film.

6. A method of reproducing data from, recording data onto, or erasing data from a phase-change optical disk including
a first phase-change recording film which phase-changes reversibly between amorphous and crystalline states when being struck by a light beam,
a first transparent substrate on which the first recording film is formed and has a thickness determined in the range from 0.2 mm to 0.4 mm,
a second phase-change recording film which phase-changes reversibly between amorphous and crystalline states when being struck by a light beam, and
a first adhesive layer which joins said first transparent substrate to said first recording film positioned so that said first transparent substrate may face the incident side of the light beam in such a manner that the light beam passed through said first transparent substrate and first recording film is projected onto said second recording film, said method of reproducing data from the optical disk comprising:
the step of generating a light beam with the wavelength of blue near about 410;
the step of converging the light beam from said incident side on one of the first and second phase-change recording films with an objective whose numerical aperture is determined in the range from 0.60 to 0.75; and
the step of processing the light beam from the recording film.

7. An apparatus for reproducing data from an optical disk including a transparent substrate whose thickness is determined in the range of 0.2 mm to 0.4 mm and a recording layer which is formed on the transparent substrate and searched by the light beam passed through said transparent substrate, said apparatus for reproducing data:
means for generating a light beam whose wavelength is selected from the range from 400 to 420 nm;
means for converging the light beam on said recording film with an objective whose numerical aperture is determined in the range from 0.60 to 0.75; and
means for processing the light beam from the recording film.

8. An apparatus for reproducing data from, recording data onto, or erasing data from an optical disk including a transparent substrate on which a light beam is projected and whose thickness is determined in the range of 0.2 mm to 0.4 mm and a recording layer which is formed on the transparent substrate and is searched, reproduced from, recorded into, or erased from by the light beam passed through the transparent substrate, said apparatus for reproducing data from the optical disk comprising:
means for generating a light beam with the wavelength of blue near about 410;
means for converging the light beam on said recording film with an objective whose numerical aperture is determined in the range from 0.60 to 0.75; and
means for processing the light beam from the recording film.

9. An apparatus for reproducing data from, recording data onto, or erasing data from a phase-change optical disk including
a first phase-change recording film which phase-changes reversibly between amorphous and crystalline states when being struck by a light beam,
a first transparent substrate on which the first recording film is formed and has a thickness determined in the range from 0.2 mm to 0.4 mm,
a second phase-change recording film which phase-changes reversibly between amorphous and crystalline states when being struck by a light beam, and
a first adhesive layer which joins said first transparent substrate to said first recording film positioned so that said first transparent substrate may face the incident side of the light beam in such a manner that the light beam passed through said first transparent substrate and first recording film is projected onto said second recording film, said apparatus of reproducing data from the optical disk comprising:
means for generating a light beam with the wavelength of blue near about 410;
means for converging the light beam from said incident side on one of the first and second phase-change recording films with an objective whose numerical aperture is determined in the range from 0.60 to 0.75; and
means for processing the light beam from the recording film.
